(19) United States
(12) Patent Application Publication
(10) Pub. No.: US 2003/0049112 A1
(43) Pub. Date: Mar. 13, 2003

(54) Mobile ramp access system for a stair barrier at an entrance way

(76) Inventor: Edwin M. Baranowski, Gahanna, OH (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 09/682,360

(22) Filed: Aug. 24, 2001

(51) Int. Cl. B60P 1/00

(52) U.S. Cl. 414/537

(57) ABSTRACT

A mobile ramp access system for the transport of a wheeled device over a stair barrier between upper and lower elevations comprising a mobile ramp having a base with at least one wheel and a hinged ramp plate that arctuately rotates between an upper vertical position and a lower position extending between the upper elevation and the lower elevation of the barrier when the ramp is in use. The mobile ramp is moveable to the stair barrier when needed for transit of the wheeled device over the stair barrier. The ramp is a universal design that can be carried by the wheelchair user or stowed out of the way when not needed.

### BACKGROUND OF INVENTION

The present invention relates to a mobile ramp adapted to be employed at an entrance way that includes one or two or more stairs. The ramp is small in size and light in weight and is both conveniently transportable by a user and readily stowable at the location of use. The ramp is wheeled and placed into position at the staired entrance way only at the times when needed.

My previous U.S. Pat. No. 5,319,818, Accessibility means for a person using a wheelchair; U.S. Pat. No. 5,517,708, Community pathway access system for wheelchair users; and U.S. Pat. No. 5,535,470, Sideways slidably mounted wheelchair access pathways are principally directed to access devices for wheelchair users at locations generally exempt from requirements of the Americans With Disabilities Act (ADA) and are premised on the proposition that personal access for wheelchair users is as important to life as is institutional and commercial access. My previous patents are directed to relatively simple devices intended to be inexpensive that are deployed when needed or perhaps on infrequent occasions when a wheelchair challenged guest encounters a stairway access barrier. Split level interiors and entrance ways that include one or two or more are examples of environments at which the devices are intended to find use.

My U.S. Pat. No. 5,499,419, Facilitator for assisting wheelchair challenged persons up and/or down inclines traversed by a pathway access system, describes a mechanism used with temporary ramps having steep or long grades to facilitate the traverse of an access barrier existing between steep grade levels. The adaptations of my previous patents were, however, site specific, in the most part, requiring custom design and manufacture for a particular site and wheelchair, e.g., manual, powered, three wheel, four wheel, etc. It is an object of the present invention to provide a mobile and standardized universal ramp system to provide on demand, as needed, access at staired entry ways.

### SUMMARY OF INVENTION

It is an object of the present invention to provide an inexpensive ramp and access system that is small in size and low in weight that is conveniently transportable by a wheelchair user for use when needed. It is a further object of the invention to provide such a ramp that is likewise adapted for temporary use at a location where access is infrequently, but historically, required such that the ramp can be purchased for permanent retention by a non-wheelchair user (for example, a restaurant owner), but is readily stowable (such as in a closet) proximate the location of use for deployment when wheelchair access is needed for passage between floor levels separated by one or two stairs. The invention provides a mobile ramp adapted to be employed at an entrance way that includes one or two or more stairs and is placed into position at the staired entrance way temporarily during the times a ramp is required.

In addition to use with wheelchairs, the ramp may also be adapted as an aid to delivery persons who use hand trucks and other wheeled transport means for heavy or bulky goods, at stairway locations.

The invention is described more fully in the following description of the preferred embodiment considered in view of the drawings in which:

### BRIEF DESCRIPTION OF DRAWINGS

FIG. 1 is a side view showing a ramp device folded up in a transport or stow mode.

FIG. 1A is a transverse cross section of the preferred ramp plate showing an integral lip or upward extending curb that stiffens the plate and enhances safety.

FIG. 2A shows a view of the mobile ramp of FIG. 1 unfolded at a staired entrance way.

FIG. 2B is a rear view of the ramp folded for storage or transport.

FIG. 3 depicts the ramp unfolded at a doorway entering to a floor elevated from a lower grade level.

FIG. 4 shows an embodiment of the device with facing/opposed planar ramp segments at either side of a carriage, adapted for access barriers higher than one stair.

FIG. 5 shows a unitized frame assembly of a base, back and handles for the device formed from a tubular metal section.

### DETAILED DESCRIPTION

In general, the invention is a mobile ramp and access system for the transport of a wheeled device over a stair barrier between upper and lower elevations. The system comprises a mobile ramp having a base with at least one wheel and a hinged ramp plate that arctuately rotates between an upper vertical position and a lower position extending between the upper elevation and the lower elevation of the barrier when the ramp is in use. The mobile ramp is moveable to the stair barrier when needed for transit of the wheeled device over the stair barrier. The ramp is a universal design that can be carried by the wheelchair user or stowed out of the way when not needed

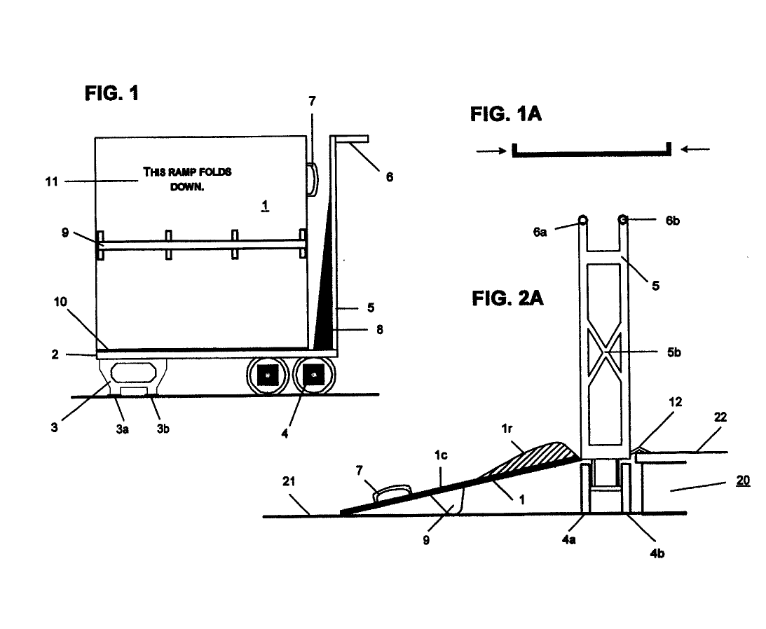

In an example of the device shown in FIG. 1, a ramp plate 1 is mounted by a hinge or other means 10 to a base, carriage or chassis 2. An intermediate support for the ramp when the ramp is in the down position is shown at 9.

The ramp plate is sized to fit a standard doorway opening dimension. For example, if a door way is 30 inches wide, the width of the plate should be such that the ramp fits within the opening, namely, somewhat less than 30 inches. The ramp plate is preferably square, having a length of the ramp approximately the same dimension as the width. Optimally, the entire device in a folded mode is sized to approximate the size of a standard adult folding wheelchair. For commercial uses, for example, for use at a 40 entrance doorway at a 7 front high stair, a 30 by 30 or 36 ramp plate is appropriate, depending on outside space availability. A narrower ramp plate, such as 24 or 26 will accommodate personal use with most adult wheelchairs. The length of the ramp plate depends on space availability. By nature however, the present ramp is unlikely to meet 1:10 height:length grade ratios. Use of the ramp assumes the availability of an assistant for safety purposes, because the limited length of the ramp plate determines a steep grade, 1:6 or 1:7, that is encountered. The ramp plate is sized to fit a standard doorway opening dimension. For example, if a door way is 30 inches wide, the width of the plate should be such that the ramp fits within the opening, namely, somewhat less than 30 inches. The ramp plate is preferably square, having a length of approximately the same dimension as the width. Size, however, is not an aspect of the invention.

The base or chassis 2 includes an extending vertical back 5 having handles 6 for pushing and directing the ramp into a position at a grade barrier, such as a staired entrance or split level separation of a home floor. Attached to the base are front support 3 (shown in FIG. 1 as a leg plate having rubber or similar cushioning foot pads 3a and 3b) and rear set of wheels or casters 4. A brace 8 reinforces the rigidity of the vertical back and base members, however a tubular unit construction, or other design material may not require reinforcement. A handle 7 is also provided for convenient manipulation of the hinged ramp plate 1 from an up to a down position and vice versa.

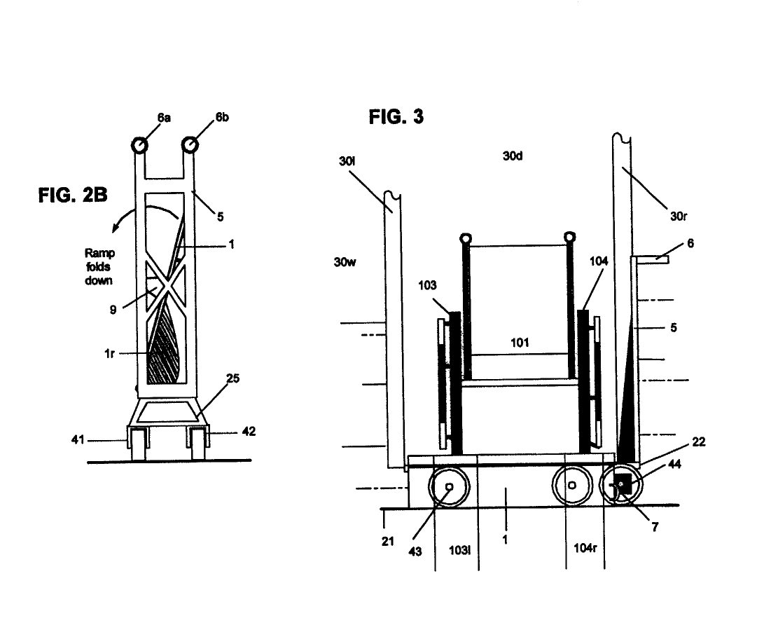

In FIG. 2A, the ramp is shown deployed at a stair 20 entrance/exit between upper level 22 and lower level 21. The same elements identified in FIG. 1, namely the ramp plate1, the vertical back 5 and handle 7 are indicated with the same numbers. In FIG. 2A the back right and left handles 6a and 6b are shown, as are rear left 4a and rear right 4b wheels, mounted on a common transverse axle 4c. The intermediate support 9 for the ramp when the ramp is unfolded is shown in a side view. The side view also shows a side rail or curb 1c at the side edge of the ramp and rest member 1r that maintains the ramp closed in an angled position on the base 2 (not indicated) when the ramp is in the up position. The back 5 includes a reinforcing cross brace 5b.

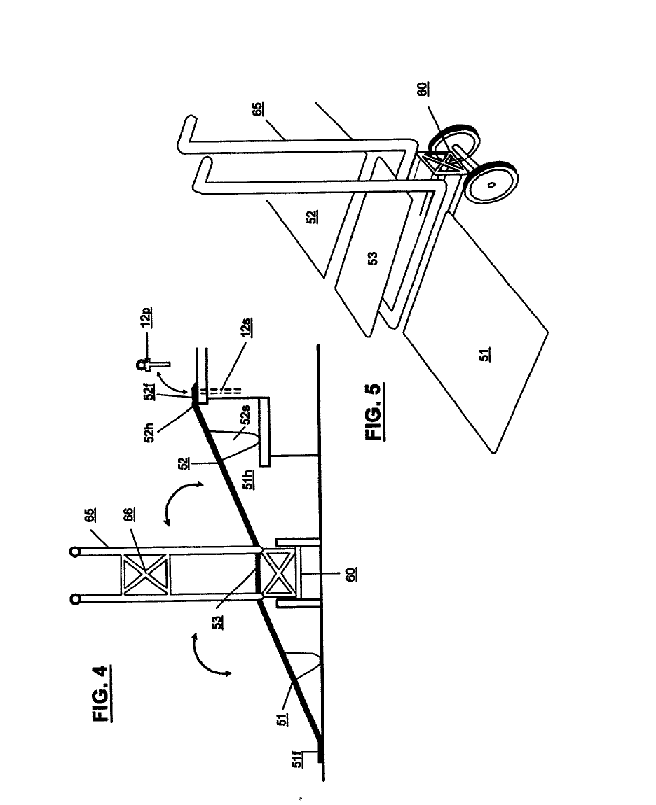

The ramp, preferably, includes a lip 12, either fixed or hinged (See also the description accompanying FIG. 4, infra.) that extends from the base to and/over the stair upper level 22. The use of a hinged lip (shown in the figures as a shallow inverted v) allows the ramp to be used with stairs having different heights, for example, a hinged lip will allow use ±1 or 2 inches up or down from a nominal design height of 6.5 inches. For example, with a hinged lip extending about 6 inches, the ramp may provide access for stairs from about 5 inches to about 8 inches high. The use of a shallow inverted v as shown is desirable when the ramp is used at an exterior door that has a lower weather strip. The inverted v covers the strip and allows unimpeded transit. The inverted v also assists in aligning and maintaining the device parallel to the doorway. For enhanced security, a removable pin, such as 12p inserted into slot 12s, as shown in FIG. 4 will secure the ramp in place, effecting a three point anchor in combination with the ramp wheels or supports.

FIG. 2B shows a rear view of the ramp folded for storage or transport with component parts consistently numbered as in FIG. 1. FIG. 2B shows a variation of the paired wheel design of FIG. 1 and FIG. 2A in which the front and rear sets of left and right wheels are paired on a common transverse axle. In FIG. 2B a chassis 25 is supported by a set of left and right casters 41 and 42. The casters may be in lie or swivel, depending on design preferences. Conventionally, front casters swivel and the rear casters are in line. As is evident with the possibility of a non-wheeled support, such as shown at 3 in FIG. 1, there are several combinations and permutations of swivel and in line wheels and casters and supports available for the unit design. When folded, the ramp takes up very little space and can readily be moved for storage in a closet or wheeled to the wheelchair user's van or car.

In FIG. 3 the ramp device is shown positioned in front of entrance or door way 30d enclosed by walls 30w at left 30l and right 30r sides of the door opening 30d. Upper grade 22 and lower grade 21 elevations are shown. In this front view, the ramp plate 1 supported by a wheel or caster assembly (here, having wheels 43 and 44 at the front and rear of the device) extends outward and downward from the door threshold at 22 forward to ground level 21. In the head on view of FIG. 3, a wheelchair is shown at 101. The preferred location of the supports or wheels or casters (43 and 44) is shown as the area directly beneath the wheels 103 and 104 of the wheelchair in a correspondence with the areas of the left and right wheel paths shown at 103l and 104r. In this manner, the supports or wheels or casters bear the load weight of the chair and its user in the course of transit over the ramp.

In FIG. 4 an embodiment of the device is adapted with facing/opposed planar ramp segments at either side of the carriage, adapted for access barriers higher than one stair. In FIG. 4, twin ramp plates 51 and 52 are hinged or rotatably mounted (as explained above with reference to FIG. 1) to a chassis/base/wheel assembly 60. In the example of FIG. 4, the device frame elements, base 2, back 5 and handles 6, are formed and unitized from a single section of a rigid tubular metal such as a stiff aluminum, shown as 65, which is reinforced by transverse brace 66. The base plate 53, to which plates 51 and 52 are hinged, is attached to the unitized frame. The ramp plates have angled flanged end sections 51f and 52f adapted to conform to the ramp surface at its beginning and end parallel to the upper level 62 and lower level 61 with which the ramp is used. The flanges may be optionally hinged with a hinge having restricted movement 51h such that the flange ends(s) are variably adapted to a presenting angle of the upper or lower level. An optional support 52s is also shown on the second ramp plate. The unitized frame formed from a single section of rigid tubular metal is shown in FIG. 5 in an exploded view of the frame 65, the first ramp plate 51, the base plate 53, and the second ramp plate (or lip) 52.

The base plate 53, to which plates 51 and 52 are hinged, is attached to the unitized frame. The ramp plates have angled flanged end sections 51f and 52f adapted to conform to the ramp surface at its beginning and end parallel to the upper level 62 and lower level 61 with which the ramp is used. The flanges may be optionally hinged with a hinge having restricted movement 51h such that the flange ends(s) are variably adapted to a presenting angle of the upper or lower level. An optional support 52s is also shown on the second ramp plate. The unitized frame formed from a single section of rigid tubular metal is shown in FIG. 5 in an exploded view of the frame 65, the first ramp plate 51, the base plate 53, and the second ramp plate (or lip) 52.

In an alternative embodiment, the device of the invention may include initially a single extended ramp plate on one side, and on the other side, allow a variety of removable plates of different lengths to allow the device to adapt to different stair environments, if desired. The plates are secured to the base by a hook, slide, toggle, lock or other suitable mechanism. In a similar manner, the ramp plate(s) and/or lip element may be supplied disassembled from the base and assembled by the user, depending on whether the ramp will be use with a left side or right side orientation with regard to an entrance.

Having described the invention in detail, those skilled in the art will appreciate that, given the present disclosure, modifications may be made to the invention without departing from the spirit of the inventive concept herein described. Therefore, it is not intended that the scope of the invention be limited to the specific and preferred embodiments illustrations as described. Rather, it is intended that the scope of the invention be determined by the appended claims.

1. An access system for the transport of a wheeled device between upper and lower elevations comprising a mobile ramp having a horizontally extending rectangular base, positioned in alignment with and at a predetermined vertical elevation with respect to the upper elevation with which the ramp is to be used, the ramp including an essentially planar and rectangular ramp plate mounted to the base at a side edge thereof by a means allowing vertical rotation of the opposite side edge of the plate along an arc segment such that the opposite side edge of the ramp plate extends to the lower elevation with which the ramp is to be used, the base being supported by one or more than one wheel that allows the mobile ramp to be temporarily positioned at the location between the upper and lower elevations to allow the transport of the wheeled device between the upper and lower elevations, the base being further connected to a back having at least one handle thereon by which the mobile ramp may be guided in transport.

2. The access system of claim 1 in which the means allowing vertical rotation of the plate is a hinge extending approximately the width of the plate.

3. The access system of claim 1 including a lip extending from the side of the base opposite the side on which the ramp plate is mounted, the lip having a vertical position adapted to extend to the upper elevation.

4. The system of claim 3 in which the lip is hinged.

5. The system of claim 4 in which the longitudinal cross sectional shape of the lip is an inverted and extended shallow v.

6. The access system of claim 1 including a pair of ramp plates, each one of the pair being mounted on a side of the base opposite the other.

7. The system of claim 1 in which the base is supported by one or more than one pair of wheels.

8. The system of claim 7 including a pair of swivel wheels.

9. The system of claim 1 in which the ramp plate includes an intermediate vertical support that extends from the underside of the ramp plate to the lower elevation when the ramp plat is in a lowered position.

10. The system of claim 2 in which one or more than one of the ramp plate and the lip is detachable.

11. The mobile ramp system of claim 1 including a brace extending between the base and the back.

12. The mobile ramp system of claim 1 including a handle on the ramp plate to facilitate the movement of the plate in the arc segment between the elevated position and the lowered position.

13. A mobile access system comprising:
a unitized tubular frame, the frame formed from a tubular metal length in an essentially squared open “U” shape having parallel extending legs, a first section of the tubular metal length forming a horizontal base section having parallel longitudinal sides, a second section of the tubular metal length extending integrally and perpendicularly from the longitudinal extent of the base section to form a vertical back from which, on both sides, a third section comprising control handles integrally and horizontally extend and terminate the tubular metal length,
at least one ramp plate mounted at a side edge to a longitudinal side of the base portion of the frame such that the plate may arctuately rotate from the mounting at its side edge between an upper position and a lower position, and
a chassis assembly including a frame and at least one wheel, the chassis assembly attached to the base portion of the frame to support the base in an elevated position with regard to a reference elevation.

14. The system of claim 13 including a brace supporting the back in a vertical relationship with the base.

15. The system of claim 13 including a transverse brace extending between the two back sections formed from the tubular metal.
